(19) United States
(12) Patent Application Publication
(10) Pub. No.: US 2017/0263078 A1
(43) Pub. Date: Sep. 14, 2017

(54) SYSTEMS, DEVICES, AND METHODS FOR OPERATING AN ELECTRONIC GAME

(71) Applicant: Bet IoT, LLC, Atlanta, GA (US)

(72) Inventor: Andrew Mound, Atlanta, GA (US)

(21) Appl. No.: 15/067,672

(22) Filed: Mar. 11, 2016

(51) Int. Cl. G07F 17/32; A63F 13/335

(52) U.S. Cl. CPC G07F 17/3244; A63F 13/335; G07F 17/329

(57) ABSTRACT

Methods, game play servers and computer-readable storage media are provided. The method includes receiving data from a wagering system indicating that a player has placed a wager, and a result of the wager including an amount won, incrementing a queued cash win value with the amount won by the player as indicated in the data, generating first game play data representing new game outcomes and cash wins based upon the queued cash win value and previously stored data, generating second game play data that impacts a future game's outcome and cash wins based upon the queued cash win value, decrementing the queued cash win value with an amount awarded and displayed, sending the first generated game play data, storing the second generated game play data, and sending a request to the wagering system to update a gaming account associated to indicate that the awarded amount is payable.

### BACKGROUND

Technical Field

The present disclosure relates to electronic gaming, and more specifically, to systems, devices, and methods for operating an electronic game playable over a network.

Description of Related Art

Lotteries generally offer games in which a player places a bet and, based on the game outcome, the player wins a cash prize or not. Popular forms of lottery games include printed instant tickets, in which the player uncovers symbols and values to potentially reveal a cash prize. In lottery draw games, a player selects or auto-selects a sub-set of numbers from a larger set of numbers and is paid according to the picked numbers selected in a future drawing outcome.

On-demand interactive lottery games are played over the Internet and allow the player to place wagers and collect winnings online. For example, when played online, the player opens an account, funds the account, selects a lottery game, and makes the wager. The request for the wager placement is provided to a wagering system, which then accepts the wager and decrements the player's account. Based upon either a pre-generated outcome or an outcome that is randomly generated, the outcome is revealed to the player, and the game is completed. If the player has won cash from the game, the player's account is incremented.

In jurisdictions in which lotteries are legal, gaming commissions oversee the execution of lotteries and regulate how and when lotteries are run. In particular, in jurisdictions in which online lottery gaming is permitted, strict rules have been constructed that not only govern the security and integrity of the games, for example, the types of games that may be played as a lottery, but also where the wagers are taken, how the outcomes of the wagers are determined, and the segregation of cash transactions from processes outside of the lottery's control. Due to the high priority of security, changes to lottery or vendor procedures are difficult to implement.

One key security requirement demonstrated in known forms of regulated remote wagering prohibits a game's final cash results from being changed by any user-controlled device. This common rule prevents a user from gaining an impermissible advantage by using software designed to corrupt or circumvent a legitimate game client. This rule also limits the transactional function of a game client to sending data to—and receiving and displaying data from—a wagering system. Thus, the user-controlled device's inability to create transactions requires all final cash results to be entirely generated by a wagering system.

Another common lottery security requirement is for on-demand game cash outcomes to be determined at or before purchase time. When implemented, this requirement prevents a game's cash outcome from being impacted by any future input.

### SUMMARY

Provided in accordance with the present disclosure is a gaming system that operates with existing online lottery games without changing any part of the existing lottery infrastructure. In particular, a game play server is provided including a processor and a memory storing instructions which, when executed by the processor, cause the game play server to receive data from a wagering system indicating that a player has placed, via a gaming device, a wager with the wagering system, and a result of the wager including an amount won by the player, increment a queued cash win value with the amount won by the player as indicated in the data received from the wagering system, generate first game play data representing new game outcomes and cash wins based upon the queued cash win value and previously stored data, generate second game play data that impacts a future game's outcome and cash wins based upon the queued cash win value, decrement the queued cash win value with an amount awarded and displayed to the player, send the first generated game play data to the player via the gaming device, store the second generated game play data, and send a request to the wagering system to update a gaming account associated with the player to indicate that the awarded amount is payable.

In an embodiment, the memory stores further instructions which, when executed by the processor, cause the game play server to, send a request to the wagering system to update the gaming account associated with the player to indicate that a remaining balance in the gaming account is payable.

In another embodiment, a balance of unpaid cash winnings in the gaming account associated with the player is maintained undisclosed to the player. In still another embodiment, the second awarded amount is different from the first awarded amount.

In another embodiment, the memory stores further instructions which, when executed by the processor, cause the game play server to, after sending the request to the wagering system to update the gaming account associated with the player to indicate that the awarded amount is payable, receive second data from the wagering system indicating that the player has placed, via a gaming device, a second wager with the wagering system, and a result of the second wager including a second amount won by the player, and increment the queued cash win value with the second amount won by the player as indicated in the second data received from the wagering system.

In another embodiment, the game play data includes multiple events and a set of conditions to be met. In an embodiment, predetermined ones of the multiple events meet conditions of the set of conditions.

In an embodiment, the game play server forms part of the wagering system.

In another embodiment, the generated game play data allows the player to play a game which is independent from a game hosted by the wagering system.

In another embodiment, the memory stores further instructions which, when executed by the processor, cause the game play server to generate game play data which enriches a game hosted by the wagering system

In another embodiment, the memory stores further instructions which, when executed by the processor, cause the game play server to generate game play data impacted by a player state.

In another embodiment, the memory stores further instructions which, when executed by the processor, cause the game play server to generate game play data impacted by time.

In another embodiment, the memory stores further instructions which, when executed by the processor, cause the game play server to generate game play data impacted by a player selection.

In another embodiment, the memory stores further instructions which, when executed by the processor, cause the game play server to generate game play data impacted by player skill.

In another embodiment, the memory stores further instructions which, when executed by the processor, cause the game play server to generate game play data impacted by a game state.

In another embodiment, the memory stores further instructions which, when executed by the processor, cause the game play server to generate game play data impacted by a persistent player state.

In another embodiment, the memory stores further instructions which, when executed by the processor, cause the game play server to generate game play data impacted by lottery drawing outcomes.

In another embodiment, the memory stores further instructions which, when executed by the processor, cause the game play server to generate game play data impacted by sports outcomes.

In another embodiment, the generated second game play data is related to the generated game play data such that the player is allowed to play a continuous game.

A method is provided for operating a computerized game, the method including receiving data from a wagering system indicating that a player has placed, via a gaming device, a wager with the wagering system, and a result of the wager including an amount won by the player, incrementing a queued cash win value with the amount won by the player as indicated in the data received from the wagering system, generating first game play data representing new game outcomes and cash wins based upon the queued cash win value and previously stored data, generating second game play data that impacts a future game's outcome and cash wins based upon the queued cash win value, decrementing the queued cash win value with an amount awarded and displayed to the player, sending the first generated game play data to the player via the gaming device, storing the second generated game play data, and sending a request to the wagering system to update a gaming account associated with the player to indicate that the awarded amount is payable.

In an embodiment, the method also includes sending a request to the wagering system to update the gaming account associated with the player to indicate that a remaining balance in the gaming account is payable.

In an embodiment, a balance of unpaid cash winnings in the gaming account associated with the player is maintained undisclosed to the player.

In another embodiment, the second awarded amount is different from the first awarded amount.

In another embodiment, the method also includes after sending the request to the wagering system to update the gaming account associated with the player to indicate that the awarded amount is payable, receiving second data from the wagering system indicating that the player has placed, via a gaming device, a second wager with the wagering system, and a result of the second wager including a second amount won by the player, and incrementing the queued cash win value with the second amount won by the player as indicated in the second data received from the wagering system.

In another embodiment, the game play data includes multiple events and a set of conditions to be met.

In another embodiment, predetermined ones of the multiple events meet conditions of the set of conditions.

In another embodiment, the generated game play data allows the player to play a game which is independent from a game hosted by the wagering system.

In another embodiment, the method also includes generating game play data which enriches a game hosted by the wagering system.

In another embodiment, the method also includes generating game play data impacted by a player state.

In another embodiment, the method also includes generating game play data impacted by time.

In another embodiment, the method also includes generating game play data impacted by a player selection.

In another embodiment, the method also includes generating game play data impacted by player skill.

In another embodiment, the method also includes generating game play data impacted by a game state.

In another embodiment, the method also includes generating game play data impacted by a persistent player state.

In another embodiment, the method also includes generating game play data impacted by lottery drawing outcomes.

In another embodiment, the method also includes generating game play data impacted by sports outcomes.

In another embodiment, the generated second game play data is related to the generated game play data such that the player is allowed to play a continuous game.

A non-transitory computer-readable storage medium storing a computer program including instructions is provided which, when executed by a processor, cause a computer to receive data from a wagering system indicating that a player has placed, via a gaming device, a wager with the wagering system, and a result of the wager including an amount won by the player, increment a queued cash win value with the amount won by the player as indicated in the data received from the wagering system, generate first game play data representing new game outcomes and cash wins based upon the queued cash win value and previously stored data, generate second game play data that impacts a future game's outcome and cash wins based upon the queued cash win value, decrement the queued cash win value with an amount to be awarded and displayed to the player, send the first generated game play data to the player via the gaming device, store the second generated game play data, and send a request to the wagering system to update a gaming account associated with the player to indicate that the awarded amount is payable.

In an embodiment, the computer program further includes instructions which, when executed by the processor, cause the computer to, send a request to the wagering system to update the gaming account associated with the player to indicate that a remaining balance in the gaming account is payable.

In another embodiment, a balance of unpaid cash winnings in the gaming account associated with the player is maintained undisclosed to the player.

In another embodiment, the second awarded amount is different from the first awarded amount.

In another embodiment, the computer program further includes instructions which, when executed by the processor, cause the computer to, after sending the request to the wagering system to update the gaming account associated with the player to indicate that the awarded amount is payable, receive second data from the wagering system indicating that the player has placed, via a gaming device, a second wager with the wagering system, and a result of the second wager including a second amount won by the player, and increment the queued cash win value with the second amount won by the player as indicated in the second data received from the wagering system.

In another embodiment, the game play data includes multiple events and a set of conditions to be met. In another embodiment, predetermined ones of the multiple events meet conditions of the set of conditions.

In another embodiment, the generated game play data allows the player to play a game which is independent from a game hosted by the wagering system.

In another embodiment, the computer program further includes instructions which, when executed by the processor, cause the computer to generate game play data which enriches a game hosted by the wagering system

In another embodiment, the computer program further includes instructions which, when executed by the processor, cause the computer to generate game play data impacted by a player state.

In another embodiment, the computer program further includes instructions which, when executed by the processor, cause the computer to generate game play data impacted by time.

In another embodiment, the computer program further includes instructions which, when executed by the processor, cause the computer to generate game play data impacted by a player selection.

In another embodiment, the computer program further includes instructions which, when executed by the processor, cause the computer to generate game play data impacted by player skill.

In another embodiment, the computer program further includes instructions which, when executed by the processor, cause the computer to generate game play data impacted by a game state.

In another embodiment, the computer program further includes instructions which, when executed by the processor, cause the computer to generate game play data impacted by a persistent player state.

In another embodiment, the computer program further includes instructions which, when executed by the processor, cause the computer to generate game play data impacted by lottery drawing outcomes.

In another embodiment, the computer program further includes instructions which, when executed by the processor, cause the computer to generate game play data impacted by sports outcomes.

In another embodiment, the generated second game play data is related to the generated game play data such that the player is allowed to play a continuous game.

Any of the above aspects and embodiments of the present disclosure may be combined without departing from the scope of the present disclosure.

### BRIEF DESCRIPTION OF THE DRAWINGS

Various aspects and features of the present disclosure are described herein with references to the drawings, wherein:

FIG. 1 is a perspective view of an electronic gaming system in accordance with the present disclosure;

FIG. 2 is a schematic diagram of a server configured for use with the system of FIG. 1;

FIG. 3 is a flowchart of an example method for operating an electronic game, according to an embodiment of the present disclosure; and

FIG. 4 is a diagram showing a flow sequence of amounts awarded and disclosed to a player based on continuity outcomes of the electronic game, provided in accordance with an embodiment of the present disclosure.

FIG. 5 is a diagram showing a flow sequence of amounts awarded and disclosed to a player based on player knowledge outcomes of the electronic game, provided in accordance with an embodiment of the present disclosure.

FIG. 6 is a diagram showing a flow sequence of amounts awarded and disclosed to a skilled player based on skill-based outcomes of the electronic game, provided in accordance with an embodiment of the present disclosure.

FIG. 7 is a diagram showing a flow sequence of amounts awarded and disclosed to an less skilled player based on skill-based outcomes of the electronic game, provided in accordance with an embodiment of the present disclosure.

FIG. 8 is a diagram showing a flow sequence of amounts awarded and disclosed to a player based on game state outcomes of the electronic game, provided in accordance with an embodiment of the present disclosure.

FIG. 9 is a diagram showing a flow sequence of amounts awarded and disclosed to a player based on player state outcomes of the electronic game in which the player is in an advantageous state, provided in accordance with an embodiment of the present disclosure.

FIG. 10 is a diagram showing a flow sequence of amounts awarded and disclosed to a player based on player state outcomes of the electronic game in which the player is in a non-advantageous state, provided in accordance with an embodiment of the present disclosure.

FIG. 11 is a diagram showing a user interface for an exemplary pachinko game in base mode, provided in accordance with an embodiment of the present disclosure.

FIG. 12 is a diagram showing a user interface for an exemplary pachinko game in fever mode, provided in accordance with an embodiment of the present disclosure.

FIG. 13 is a diagram showing a data flow sequence between a wagering system, a game play server, and a wagering device, provided in accordance with an embodiment of the present disclosure.

### DETAILED DESCRIPTION

The present disclosure is directed to systems, devices, and methods for operating an electronic game. In an embodiment, amount won data is received by a game play server from a wagering system as a result of a wager, instead of being returned to a device that initiated the wager. The game play server adds a value corresponding to the amount won data to a stored value representing a sum of all historical amount won data values less a value that is equal to the sum of all historical values awarded to the player via the system. The game play server then generates new game play data which can award any amount less than or equal to the stored value and can be influenced by additional factors, such as player input or state information stored from previous games.

The generated game play data and awards are sent to the device that initiated the wager, which interprets the generated game play data and presents results to the player via a display. When a game accepts additional player input, additional and/or updated game play data and awards can be generated for, and be attributable to, the same wager. The additional and/or updated game play data is then sent to the device that initiated the wager and is presented to the player. When all game play associated with a specific wager has been generated and the sum of all awards associated with the specific wager is greater than zero, a request is sent by the game play server to the wagering system to pay the sum value of the awards associated with the specific wager and revealed to the player for the active wager. Though a portion of winnings from the stored value may remain hidden from the player at the conclusion of any process associated with an individual wager, the stored value may be awarded in its entirety in a future game or may be revealed in its entirety and awarded when a reset request is initiated via wagering system business rules or a verified administrator.

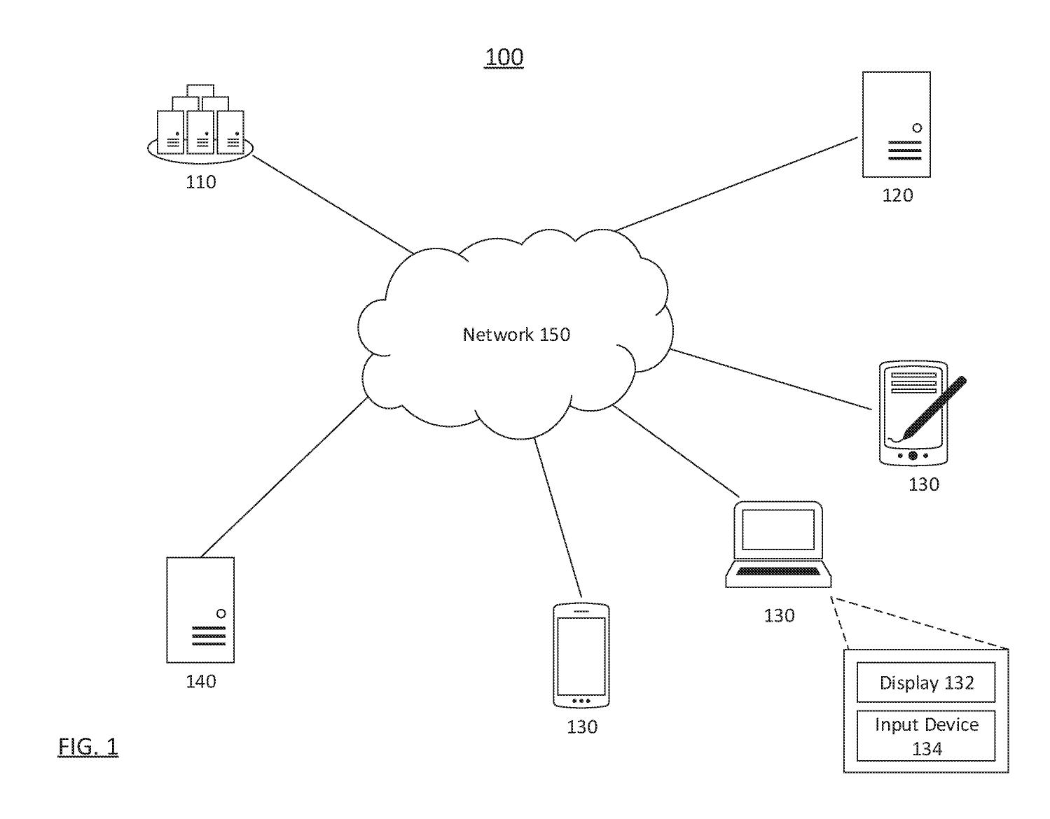

With reference to FIG. 1, a simplified diagram is provided of a system 100 which may be used to operate an electronic game according to an embodiment of the present disclosure. System 100 includes a wagering system 110, a game play server 120, various gaming devices 130, and an account server 140, all connected via a network 150.

Wagering system 110 may be any server, or array of servers, managed by a gaming authority, such as a state gaming commission, used to operate electronic wagering games and to determine winning allocations. Wagering system 110 may include one or more servers dedicated to the operation of a lottery game, player management, accounting, and/or other functions used to operate the lottery game. The term “lottery game” as used herein refers to any game wherein a player is allowed to place a wager on the outcome of a game using an electronic device, and winnings are determined by a drawing or a pseudo-random number generator, and/or are generated in advance as with a predetermined pool of outcomes. Examples include on-demand lottery games, such as interactive versions of instant tickets or slot machines, which are operated by state gaming authorities, as well as those operated by gaming commissions of foreign jurisdictions.

Game play server 120 may be any server, or array of servers, used to operate an electronic game. As described further below, game play server 120 interfaces with wagering system 110 to operate an electronic game that enhances and/or enriches the lottery game operated by wagering system 110. Game play server 120 may be one or more servers dedicated to the operation of the electronic game and/or a cloud-based server installation used to operate the electronic game. In an embodiment, game play server 120 and wagering system 110 are combined into a single server, or array of servers, configured to operate both the lottery game and the electronic game. The term “electronic game” as used herein refers to various games or features that may interface or interact with the lottery game to enhance and/or enrich the player's experience of the lottery game, as described further below.

Gaming devices 130 (referred to hereinafter collectively as “gaming device 130”) may be any computing device operable by a player to play an electronic game. Examples include personal computers such as desktop computers, laptop computers, etc.; mobile devices such smart phones, smart watches, tablets, electronic readers, etc.; gaming devices, such as portable gaming devices, video game consoles, etc.; gambling or gaming devices, such as gambling machines and lottery machines; and/or any other electronic device which can be configured to play the electronic game operated by game play server 120. As described further below, gaming device 130 interfaces with wagering system 110 to allow a player to play the lottery game, and interfaces with game play server 120 to allow the player to play the electronic game. Each gaming device 130 includes one or more displays 132 for displaying the electronic game to the player and one or more player input devices 134 for permitting the player to provide inputs to play the electronic game.

Account server 140 may be any server, array of servers, and/or other computing device configured to manage player accounts. Account server 140 interfaces with wagering system 110 and/or game play server 120 to manage player accounts and to keep track of winnings allocated to the player and funds disclosed to the player. Account server 140 may be an independent server or may be integrated into wagering system 110 and/or game play server 120. Additionally, account server 140 manages one or more accounts associated with the player. In an embodiment, account server 140 manages an undisclosed winnings account, the balance of which is maintained undisclosed to the player, and a paid winnings account, the balance of which is disclosed to the player. In another embodiment, account server 140 manages a single account associated with the player, which includes amounts which are maintained undisclosed to the player, and amounts which are disclosed to the player. In an embodiment, account server 140 is managed by external auditors separate from the operators of wagering system 110 and/or game play server 120.

Network 150 may be any network used to connect and facilitate communication between wagering system 110, game play server 120, gaming device 130, and account server 140, such as a local area network (LAN) consisting of a wired network and/or a wireless network, a wide area network (WAN), a wireless mobile network, a Bluetooth network, and/or the Internet.

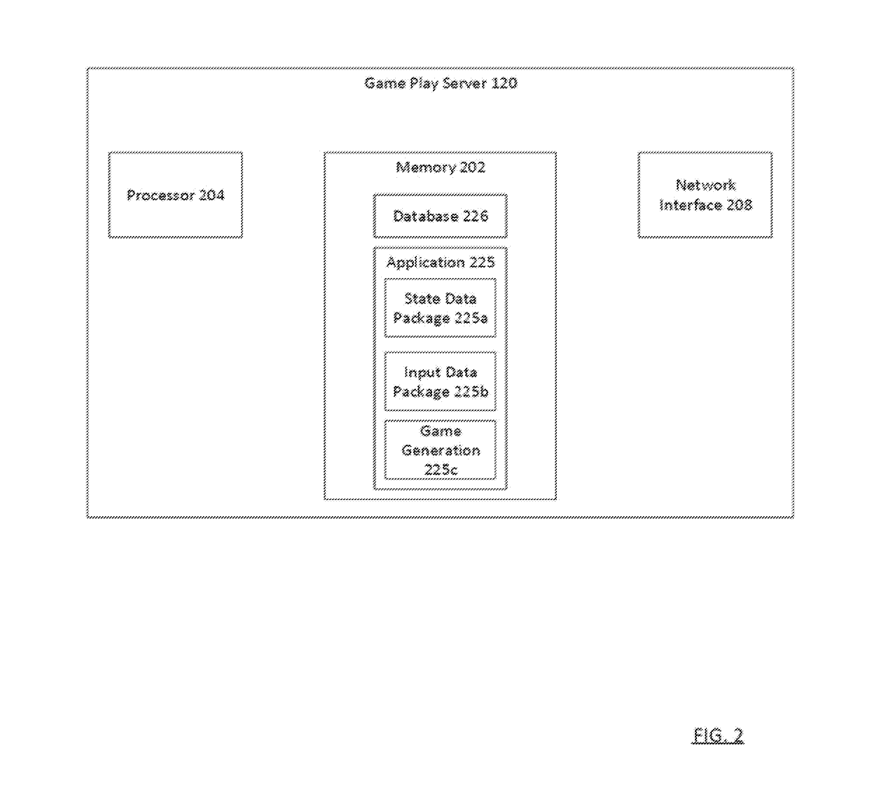

To operate the electronic game, game play server 120 is equipped with at least a memory 202, a processor 204, a display 206, a network interface 208, and an input device 210, as shown in FIG. 2. Memory 202 stores an application 225, which, when executed by processor 204, causes game play server 120 to create and operate the electronic game. Application 225 may include instructions for receiving data from wagering system 110, creating the electronic game by generating game play data representing new game outcomes and cash wins, and sending requests to wagering system 110 and/or account server 140 to update gaming accounts associated with particular players indicating an awarded amount. Application 225 may also include instructions to store a queued cash win value or any other data in database 226 that can impact future game play.

In this regard, according to an embodiment, application 225 includes various modules configured to assemble packages for the generation of the game play data. Application 225 includes a State Data Package assembly module 225a, an Input Data Package assembly module 225b, and a Game Generation module 225c.

State Data Package assembly module 225a is configured to assemble a State Data Package, in response to game play server 120 receiving a request for a game outcome. A State Data Package can incorporate state information associated with an active player, a game, elapsed time, queued cash win value, or any game-related data that persists and updates from one game to another. For example, a State Data Package might include an integer that represents a metagame in which a player collects “power up” symbols. A “metagame” refers to a game or feature that enhances and/or enriches the player's experience in more than one lottery game offering, persists for more than one wagering cycle, and/or integrates with non-game elements such as a menu system, a promotional system, a rewards system, a system that conducts second-chance lottery drawings, a system that conducts AB testing, social media, external application programming interfaces (APIs) and/or email marketing. Thus, for example, over weeks of separate play sessions and across different games, a player may collect the “power up” symbols during random events. After a total of 10 “power up” symbols are collected, the “power up” feature may be activated, providing an opportunity for wins from 10 future games to be doubled when played.

The State Data Package is configured to be used for the generation of the game. To assemble the State Data Package, State Data Package assembly module 225a may either generate or obtain a player identification (ID) associated with a particular player and generate or obtain a game instance ID, a jurisdiction ID, and a session ID. The game instance ID and the session ID identify particular games and gaming session instances for gaming integrity purposes. The jurisdiction ID identifies a jurisdiction, for example, a state or country, with which the player or wagering system 110 is associated and may enable or disable functions as preferred by regulators and operators. In addition to the various IDs, a play history associated with the particular player ID, game instance ID, and/or group of player IDs, if any, is also obtained and can be incorporated with in State Data Package.

Input Data Package assembly module 225b is configured to assemble an Input Data Package for the generation of the game. The Input Data package may include input data retained from a previous game, in an embodiment. In another embodiment, the input data can be used by the gaming device 130 to request an additional set of game play data and award data from the game play server 120 that can impact a total award for a game sequence associated with current and/or future wagers.

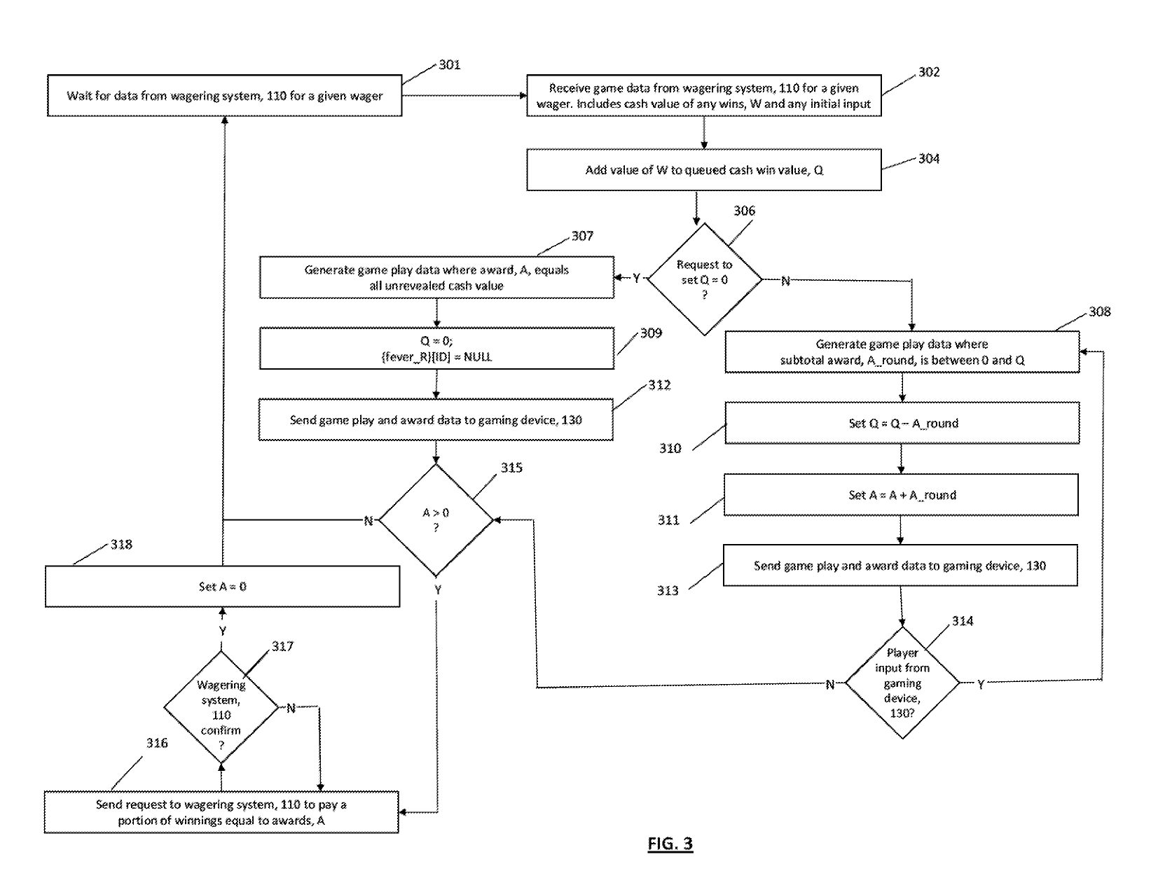

Referring now to FIG. 3, there is shown a flowchart of an example computer-implemented method 300 for operating an electronic game on game play server 120, in accordance with an embodiment of the present disclosure. Method 300 may be implemented, at least in part, by processor 204 executing application 225 stored in memory 202 (FIG. 2). Additionally, the particular sequence of steps of method 300 shown in FIG. 3 is provided by way of example and not limitation. Thus, the steps of method 300 may be executed in sequences other than the sequence shown in FIG. 3 without departing from the scope of the present disclosure. Further, some steps shown in method 300 of FIG. 3 may be concurrently executed with respect to one another instead of sequentially executed with respect to one another.

At block 301, game play server 120 waits for incoming data to be sent from a wagering system 110.

At block 302, data is received from a wagering system including any cash amount won by a player (W). In accordance with an embodiment, the data is generated after the player places a wager at wagering system 110 by using gaming device 130. It will be appreciated that the cash amount won by the player (W) is predetermined by wagering system 110. After the data is generated, the data is sent to, and thus received by, game play server 120. The data received from wagering system 110 indicates that the player has placed a wager at wagering system 110 and includes the result of the wager including any cash amount won by the player (W).

At block 304, game play server 120 increments a queued cash win value (Q) with the cash amount won by the player (W) as indicated in the data received from wagering system 110 in block 302. For example, game play server 120 may track the queued cash win value (Q) as stored data associated with the player. The queued cash win value (Q) reflects the amount of winnings the player has won from wagers placed on the lottery game operated by wagering system 110, but which has not yet been disclosed to the player. As such, the queued cash win value (Q) in the data associated with the player is not known to the player. It is also possible for additional queued cash win values (Q) to be exclusively present in outcomes that are generated by application 225 and not yet matched with a triggering event. These winnings exist as part of stored sequence data ({fever_R}[ID]) that will be triggered by events that have not yet been generated by Game Generation module 225c. The value of this set of unrevealed cash awards may be indicated as (fever total). Therefore, the sum of all unrevealed cash awards is equal to the queued cash win value (Q) and the value of the set of unrevealed cash awards (fever total).

At block 306, game play server 120 determines whether any directive is active to reset the value of queued cash win value (Q) initiated via wagering system business rules or via a verified administrator. If so, game play data is generated that pays the sum of all unrevealed cash awards (e.g., 100% of the queued cash win value (Q) and the value of the set of unrevealed cash awards (fever total)) in block 307.

To generate the game play data to be sent in block 307, Game Generation module 225c of application 225 generates game play data using data from State Data Package assembly module 225a and Input Data Package assembly 225b. The generated game play data enables the player to play various electronic games. In an embodiment, the electronic games are independent from the lottery game. For example, the player input may indicate a game selection of a slot game, a pachinko game, instant ticket themed game, poker game, or other casual or wagering game, which may be implemented as a game or series of games generated as the game play data irrespective to any game play included in the lottery game operated by wagering system 110. In another example, the player input may indicate a game selection of a lottery game that may be an extension of the lottery game operated by wagering system 110. Additionally, the electronic game may enhance and/or enrich the lottery game operated by wagering system 110.

Then, in block 309, the queued cash win value (Q) is set to zero and the stored sequence data ({fever_R}[ID]) is set to NULL. The game play data and award data are then sent to the gaming device in block 312.

If it is determined at block 315 that the value of awards (A) is greater than zero, a request is sent to wagering system 110 to pay a portion of winnings equal to the value of awards (A) at block 316. After wagering system 110 confirms that it has received the request at block 317, the value of awards (A) is set to zero at block 318. Method 300 then iterates at block 301, where game play server 120 then waits at block 301 for more data to be sent from wagering system 110. If the value of awards (A) equals 0 at block 315, method 300 iterates at block 301, where game play server 120 waits for more data.

Returning to block 306, if a determination is made that no directive is active to reset the value of queued cash win value (Q), game play server 120, at block 308, generates game play data representing new game outcomes and cash wins based upon the queued cash win value (Q). Queued cash win value (Q) is updated by subtracting a generated award (A_round) from the queued cash win value (Q) at block 310, adding the value of the generated award (A_round) to the value of awards (A) in block 311. Game play data and award data are sent to gaming device 130 at block 313.

When the electronic game incorporates feedback or input from the player at block 314, an additional set of play data may be generated at block 308, along with additional awards, additional updating of queued cash win value (Q) at block 310, additional updating of the award value (A) at block 311, and second game play data and award data being sent to the gaming device 130 at block 313. When no additional player input is needed to complete the game initiated by the wager, at block 314, the total value of awards (A) are evaluated in block 315. If the value of awards (A) is greater than zero, a request is sent to wagering system 110 to pay a portion of winnings equal to the value of awards (A) at block 316. Once wagering system 110 confirms that it has received the request at block 317, the value of (A) is set to zero at block 318. Method 300 iterates at block 301, where game play server 120 again waits for more data to be sent from wagering system 110.

By implementing the above-described method 300, though game play server 120 has no opportunity to impact the final cash amount to be paid to a player, game play server 120 can generate game and award outcomes that are influenced by additional input.

In an example, game play server 120 queues the value associated with pre-determined cash results and instructs wagering system 110 to make portions of the pre-determined cash awards available to the player according to events in a game. In an embodiment, game play server 120 may be configured to provide a bonus feature that offers $10 for a correct answer to a trivia question can only be offered when at least $10 is available in queued cash win value (Q). If the feature is offered and the player guesses incorrectly, the $10 remains in queued cash win value (Q) and will be awarded in the future. This configuration encourages a player to perceive that cash awards are affected by their actions, such as a correct trivia answer. In another example, game play server 120 may be configured to provide a scratch ticket-themed interactive game to offer enriched pays for the next 20 bets. For example, a player may make 10 bets today and 10 bets after a week has passed. This configuration encourages a player to return to a specific game while it appears in this state. In other examples, game play server 120 may be configured to provide electronic games such as shooting types of games, which may be perceived by the player to require skill. No matter the skill or effort put forth, the cash outcome is still predetermined.

In another example, game play server 120 is configured to provide electronic games that do not have predetermined cash outcomes. In these embodiments, queued cash win value (Q) and/or stored game outcomes that have not yet been awarded ((fever_R)[ID]) may be associated with a non-player entity, such as a gaming machine, game instance, game system, or group of players.

In other embodiments, game server 120 may be used to award drawing entries in a second-chance lottery drawing, rewards/loyalty club points, or other non-cash units. It is envisioned that non-cash units, pre-determined prizes, non-pre-determined prizes, and any other form of prize can co-exist in the same game and/or game system.

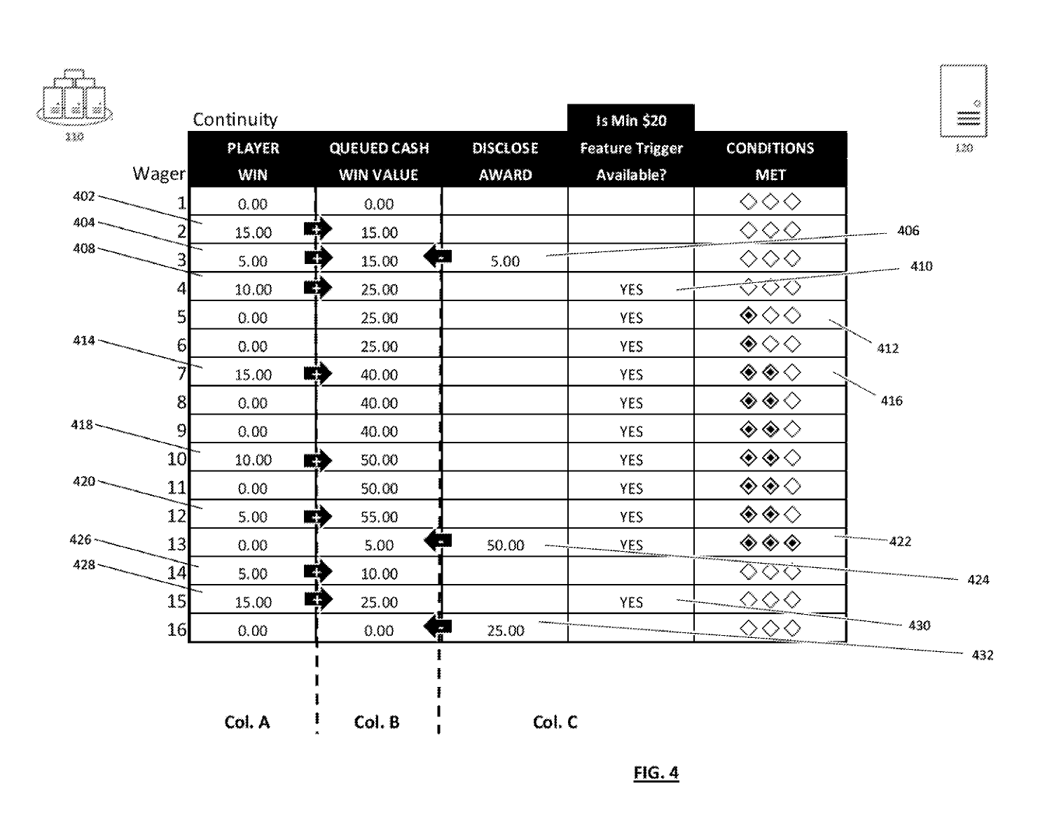

FIG. 4 is a diagram illustrating a flow sequence of operating wagering system 110 and an electronic game operated by game play server 120, in accordance with an embodiment. Here, a continuity-based metagame feature is described in which a series of events occur over the span of a series of separate wagers. For instance, the flow sequence shown in FIG. 4 illustrates amounts awarded and disclosed to the player over a series of 16 separate wagers. Column A represents amounts awarded to the player (W) by wagering system 110, column B represents a queued cash win value (Q) maintained by game play server 120, and column C represents events of the electronic game operated by game play server 120. In column C, the events of the electronic game operated by game play server 120 include disclosing an award (A), determining whether a minimum $20 feature is triggered, and determining whether conditions are met. The minimum $20 feature is triggered when the queued cash win value (Q) of column B is equal to or exceeds $20. The conditions to be met may be any one of numerous conditions generated for the electronic game. Although three conditions are shown as needing to be met, it will be appreciated that fewer or more may be included in other embodiments.

Referring to wager 1, the queued cash win value (Q), as shown in column B, begins at $0. At step 402, wagering system 110 awards the player $15 winnings based on an outcome of a wager the player placed on the lottery game. Upon notification of the award, game play server 120 increments the queued cash win value (Q) associated with the player in column B by $15.

At step 404, wagering system 110 awards the player $5 winnings based on an outcome of another wager the player placed on the lottery game. At step 406, game play server 120 discloses to the player $5 from the queued cash win value (Q) based on an outcome or on an event of the electronic game operated by game play server 120 that is portrayed as a result of the wager described in step 404. At step 408, wagering system 110 awards the player $10 based on an outcome of another wager the player placed on the lottery game and adds the $10 winnings to the queued cash win value (Q) to bring the value to $25. At step 410, the queued cash win value (Q) is verified as equaling or exceeding the required minimum trigger value of $20. Thus, it is determined that enough cash is available to trigger a feature that is required to pay at least $20 through subsequent game play.

The player continues to play multiple events that make up the electronic game operated by game play server 120. Then, at step 412, a first one of the set of three conditions is met. The player makes additional separate wagers and, at step 414, wagering system 110 awards the player $15 based upon the outcome of another wager the player placed on the lottery game, which then added to the queued cash win value (Q) to yield at total of $40. At step 416, a second one of the set of three conditions is met. As can be seen in FIG. 4, not every game sequence resulting from a given wager will satisfy a condition of the set of conditions. Subsequently, game play continues where the player continues to make additional wagers.

At step 418, following another wager placed by the player on the lottery game operated by wagering system 110, wagering system 110 awards the player $10 and notifies game play server 120 to increment the queued cash win value (Q) associated with the player by $10, bringing the total queued cash win value (Q) to $50. At step 420, following a subsequent wager placed by the player on the lottery game operated by wagering system 110, wagering system 110 awards the player $5 and notifies game play server 120 to increment the queued cash win value (Q) associated with the player by $5 to yield at total of $55.

At step 422, all of the conditions in the set of three conditions are met, and game play server 120 generates a game feature which discloses to the player $50 from the queued cash win value (Q) for completing the electronic game at step 424. This causes game play server 120 to send a request to lottery server to pay to the player $50 from an undisclosed winnings account (which is not maintained on game play server 120) associated with the player. It will be appreciated that the $50 win disclosed to the player occurs in response to a game event corresponding to a wager in which no cash was won by the player from wagering system, 110. Additionally, as a result of the disclosure, the queued cash win value ((Q) is reduced to $5.

At step 426, following a subsequent wager placed by the player on the lottery game operated by wagering system 110, wagering system 110 awards the player $5 winnings, and notifies game play server 120 to increment the queued cash win value (Q) associated with the player by $5 for a total of $10. At step 428, following a subsequent wager placed by the player on the lottery game operated by wagering system 110, wagering system 110 awards the player $15 and notifies game play server 120 to increment the queued cash win value (Q) associated with the player by $15 to yield a total of $25. At step 430, the queued cash win value is verified as equaling or exceeding the required minimum trigger value of $20. Thus, it is determined that enough cash is available to trigger another feature that is required to pay at least $20 through subsequent game play.

Thereafter, at step 432, the player requests a cash out of any remaining unpaid winnings, which causes game play server 120 to send a request to lottery server to pay to the player the remaining balance of the undisclosed winnings account associated with the player.

While the above example starts and ends with a queued cash win value of $0, it is envisioned that the electronic game may be operated continuously such that the player does not cash out the remaining unpaid winnings, but rather that the queued cash win value may be carried over to another electronic game play session where the player again plays the electronic game operated by game play server 120 and queued cash win value starts out with a non-$0 balance.

It is also envisioned that, after a period wherein the player is inactive and does not play the electronic game operated by game play server 120 but a positive queued cash win value remains, game play server 120 will notify wagering system 110 of the inactivity such that wagering system 110 may determine to cash out the remaining balance of the undisclosed winnings account associated with the player.

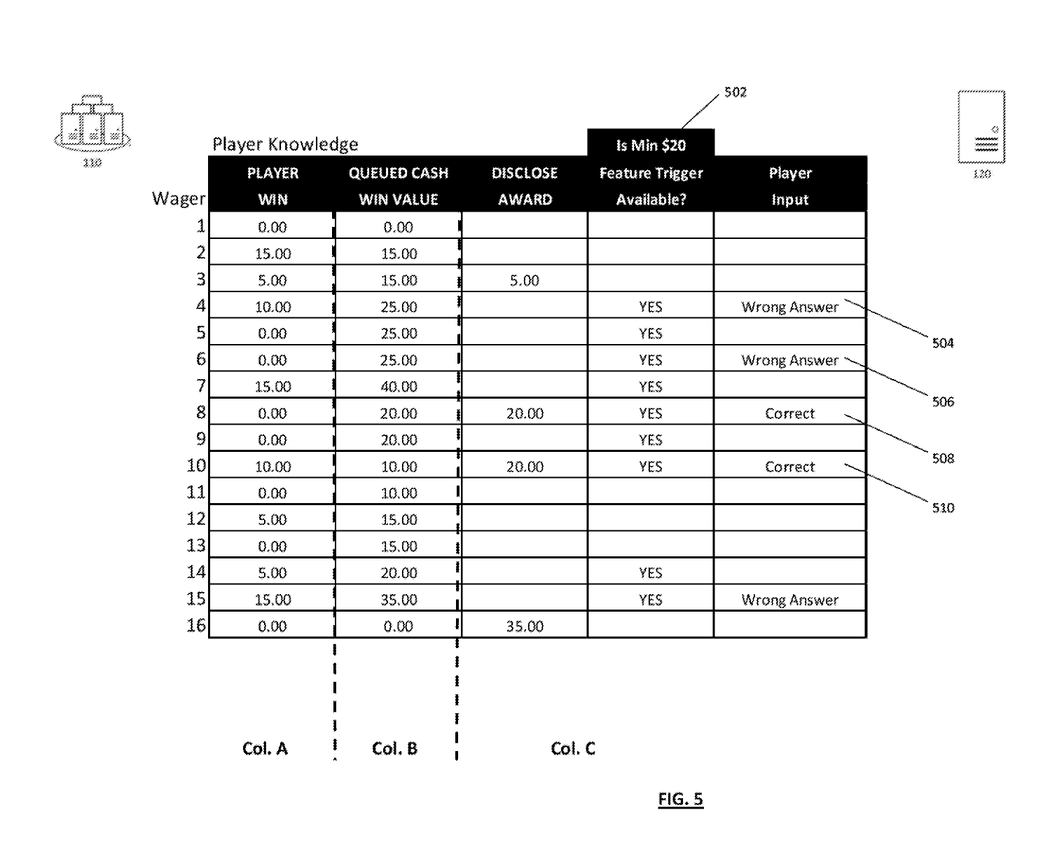

Turning now to FIG. 5, a grid-based diagram is provided illustrating a flow sequence of operating wagering system 110 and an electronic game operated by game play server 120, in accordance with another embodiment. Here, a player is awarded for demonstrating knowledge, as in a response to a trivia question. For comparison, all amounts awarded to the player (W) by wagering system 110 in Column A as included in FIG. 5 are identical to those shown in Columns A and B of FIG. 4. Column C of FIG. 5 is substantially similar to Column C of FIG. 4, except that when the queued cash win value (Q) is equal to or exceeds the minimum $20 trigger feature, a trivia feature may be activated at the discretion of game play server 120.

At steps 504 and 506, game play server 120 presents the player with opportunities to answer trivia questions. After the player responds to each of the questions, game play server 120 determines the player's answers to be incorrect and each time generates additional game play data that does not include an additional award. Thus, the value of the queued cash win value (Q) are unchanged.

At steps 508 and 510, game play server 120 presents the player with additional opportunities to answer trivia questions. Game play server 120 determines the player's answer to be correct and generates additional game play data that includes an additional award. Thus, the value of the queued cash win value (Q) and award disclosed (A). In each of steps 508 and 510, game play server 120 sends a request to wagering system 110 to pay to the player $20 from the undisclosed winnings account associated with the player.

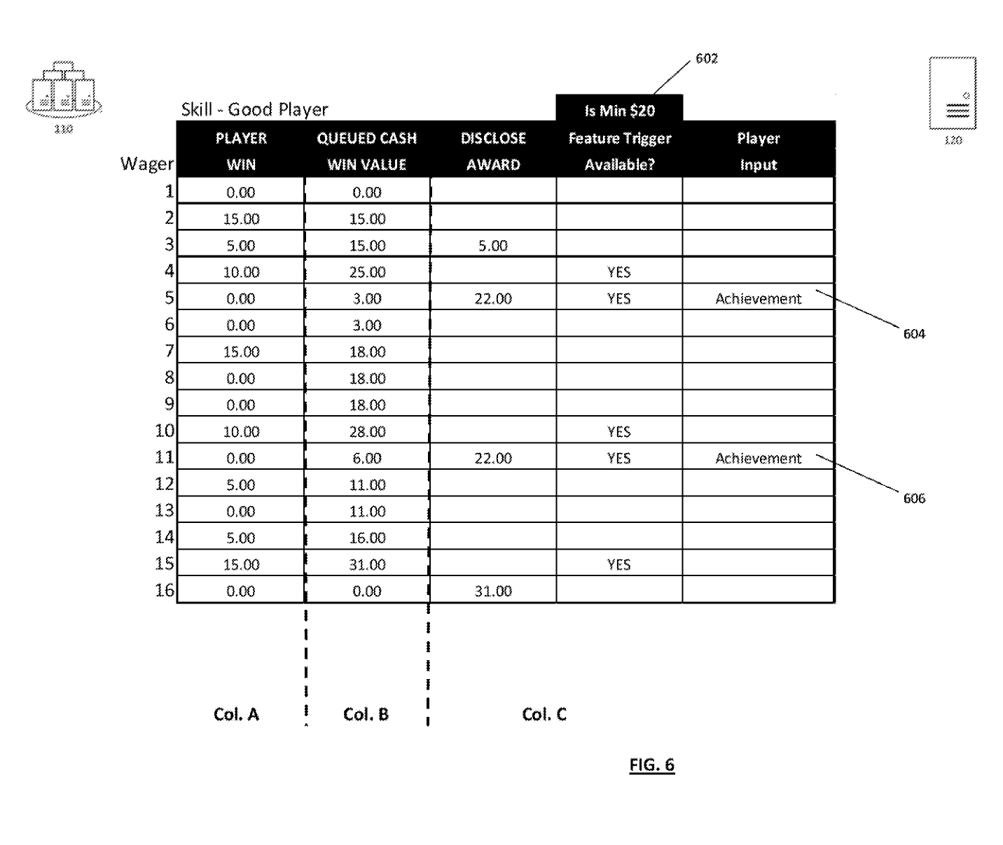

In another embodiment, FIG. 6 is a grid-based diagram illustrating a flow sequence of operating wagering system 110 and an electronic game operated by game play server 120, in accordance with still another embodiment. The flow sequence illustrates an embodiment in which a skilled player is awarded for demonstrating skill, as in a casual game genre. As an example, the game may consist of a “match 3” play style as popularized by games such as “Candy Crush Saga” provided by King.com Ltd. and “Bejeweled” by PopCap Games. In these games, a player is awarded a number of points based upon matching a number of like symbols. Larger point values can be achieved when special symbols are combined. In this example, when special symbols are not available in a sufficient quantity, it is impossible for a player to collect a large enough point value to complete a required achievement. For comparison, all player wins shown in Column A in FIG. 6 are identical to those shown in Column A in FIG. 4. Column C of FIG. 6 includes a minimum $20 trigger feature; however, when the queued cash win value (Q) is equal to or exceeds the minimum $20 trigger feature, game play server 120, at its discretion, may permit the player to complete an achievement by including enough special symbols in a generated game so that a skilled player can complete the required achievement. For example, in a match 3 game, game play server 120 would generate a sufficient number of special symbols to allow the player to collect a particular point value and thereby complete the required achievement. Alternatively, when there is insufficient queued cash win value (Q) available, it will be impossible for even the most skilled player to complete the required achievement. In an embodiment as illustrated in FIG. 6, the skilled player completes achievements in steps 604 and 606, each time causing game play server 120 to disclose awards to the player. For example, at each of steps 604 and 606, $22 amounts are disclosed.

In an embodiment, it is possible for the game's achievement to be completed by the player on gaming device 130, and provided as player input (see e.g., block 314). Though input from gaming device 130, is potentially susceptible to cheating, doing so cannot result in a player being awarded any additional cash awards that exceed queued cash win value (Q). Further, a player wishing to collect the full value of queued cash win value (Q) may request a cash out of any remaining unpaid winnings, which causes game play server 120 to send a request to lottery server to pay to the player the remaining balance of the undisclosed winnings account associated with the player.

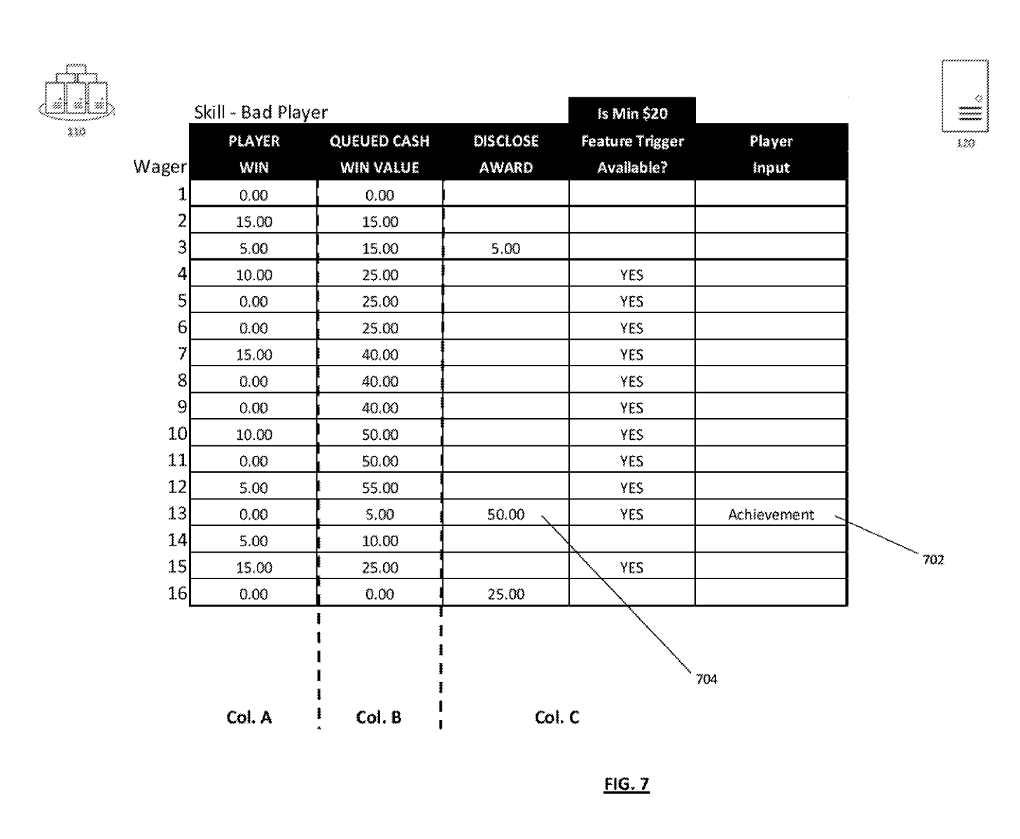

In another embodiment, FIG. 7 is a grid-based diagram illustrating a flow sequence of operating wagering system 110 and an electronic game operated by game play server 120, in accordance with still yet another embodiment. Here, the flow is similar to that described for FIG. 6, except in this sequence a less-skilled player is awarded for demonstrating skill, as in a casual game genre. After placing multiple wagers and accumulating a queued cash win value (Q) as indicated in Column B, the less-skilled player finally completes an achievement at wager #13 triggering an award value to be disclosed. Because the queued cash win value (Q) had been allowed to accumulate over a longer series of wagers than as shown in FIG. 6, the award disclosed by game play server 120 is larger than the award disclosed to the skilled player, as shown in step 704.

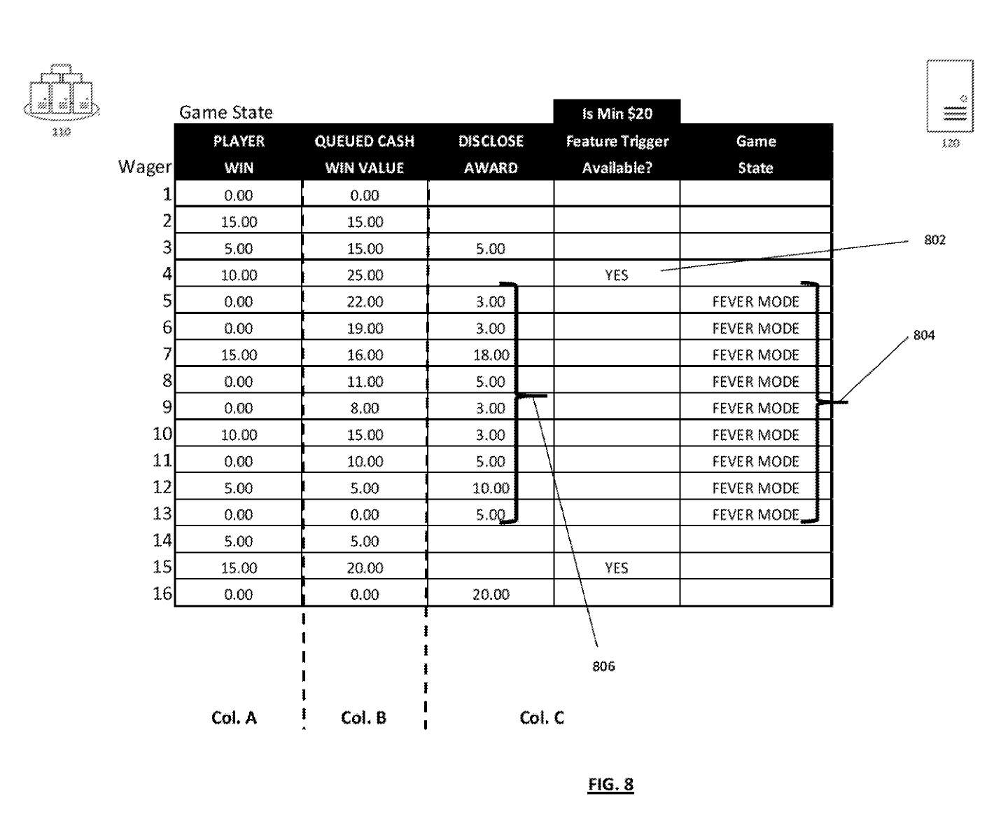

FIG. 8 is a grid-based diagram illustrating a flow sequence of operating wagering system 110 and an electronic game operated by game play server 120, in accordance with still yet another embodiment. In this embodiment, the game state changes and awards a series of future enriched games based upon future wagers, known as “fever games”. Similar to the above figures, Column A represents amounts awarded to the player (W) by wagering system 110, column B represents a queued cash win value (Q) maintained by game play server 120, and column C represents events of the electronic game operated by game play server 120. In column C, the events of the electronic game operated by game play server 120 include disclosing an award (A), determining whether a minimum $20 feature is triggered, and determining whether a game is in a “fever mode” game state. As noted above, the minimum $20 feature is triggered when the queued cash win value (Q) of column B is equal to or exceeds $20.

When a wager is made and it is determined in step 802 that sufficient queued cash win value (Q) in Column B is available, game play server 120, at its discretion, may enable a fever mode game state 804. While in the fever mode game state 804, an instant ticket-themed game might be implemented to award an additional cash prize on top of normal prizes 806. In this example, the fever mode game state is active during game sequences initiated by wagers 5-13. For each of the wagers during this fever mode game state, game play server 120 causes the electronic game to disclose to the player portions of queued cash win value (Q), which appear to the player as additional awards $3, $3, $18, $5, $3, $3, $5, $10, and $5 corresponding to wagers 5-13. It will be appreciated that the amount awarded by game play server 120 in any given game sequence initiated by a wager and/or the length of the game state can be affected by an updated queued cash win value (Q). In another embodiment, fever games are generated in advance causing award values to be deducted from the queued cash win value, (Q), before Game Generation Module 225c has determined when and how the award values will be revealed.

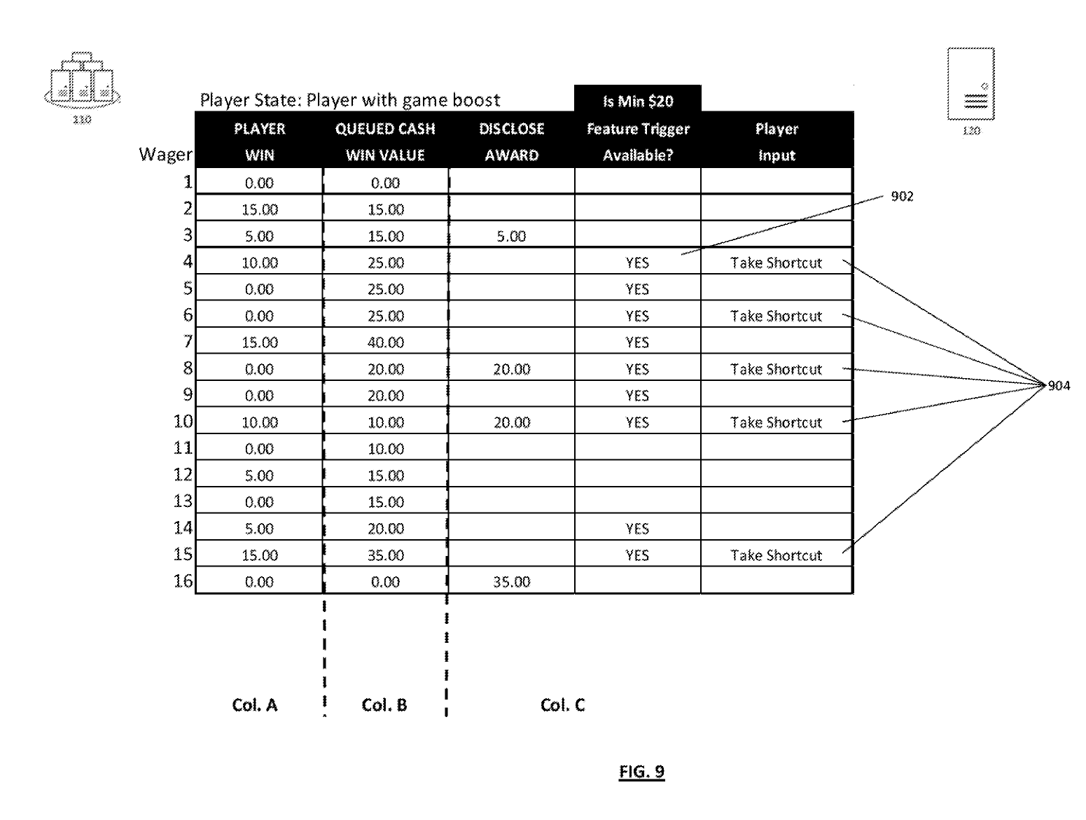

In another embodiment, FIG. 9 illustrates a flow sequence of operating wagering system 110 and an electronic game operated by game play server 120, in accordance with still another embodiment. In FIG. 9, a persistent player state changes, which changes the difficulty for a player to complete an achievement and be awarded a prize from game play server 120. As with the previous flow sequences, Column A represents amounts awarded to the player (W) by wagering system 110, column B represents a queued cash win value (Q) maintained by game play server 120, and column C represents events of the electronic game operated by game play server 120. In this example, electronic game presents the player with a maze game, the completion of which provides the player with access to a cash prize. When the persistent player's state incorporates a “game boost”, game play server 120 provides a shortcut in the maze, thus decreasing the difficulty for the player to collect the prize. After a wager is made and a sufficient queued cash win value (Q) is accumulated in Column B in step 902, game play server 120 may enable the shortcut game boost at its discretion. Thus, attempts made by the player after placement of subsequent wagers 904 are more likely to be successful while the shortcut game boost is enabled in the persistent player state. Here, the queued cash win value (Q) is sufficient to trigger the shortcut game boost at wagers 4-10, and the player takes the game boost shortcut at wagers 4, 6, 8, and 10. At wagers 8 and 10, the player completes the mazes and reaches the achievements, causing game player server 120 to disclose award values of $20 at each turn.

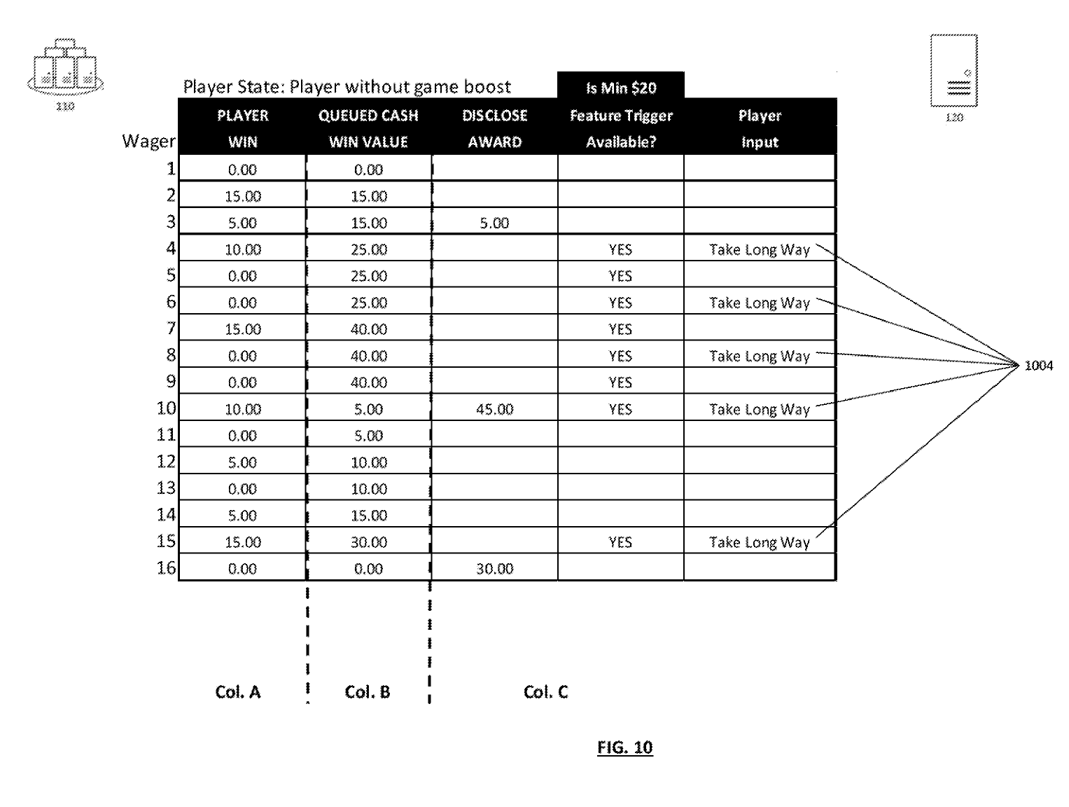

FIG. 10 illustrates a flow sequence of operating wagering system 110 and an electronic game operated by game play server 120, in accordance with still another embodiment. The flow sequence in FIG. 10 is similar to the flow sequence in FIG. 9, except the persistent player state does not include the shortcut game boost. Here, Column A represents amounts awarded to the player (W) by wagering system 110, Column B represents a queued cash win value (Q) maintained by game play server 120, and Column C represents events of the electronic game operated by game play server 120. The player in the flow sequence in FIG. 10 makes the same number of attempts in step 1004 as demonstrated in steps 904, however the player is less successful because game play server 120 does not enable the shortcut game boost in the persistent player state. Thus, game play server 120 does not permit the player in FIG. 10 to reach the achievements as frequently and thus does not succeed at collecting a cash prize as frequently as the player in FIG. 9.

In another embodiment, game play data may be impacted by external factors, such as time. For example, the shortcut game boost demonstrated in FIG. 9 and FIG. 10 may be enabled or disabled based upon a displayed timer or holiday. Further, external data from lottery drawing outcomes, sports outcomes or other external events may be used to impact player state, game state, or player skill. As an example of player skill, a trivia feature, as demonstrated in FIG. 5 could include trivia questions based upon and triggered by a recent sporting event.

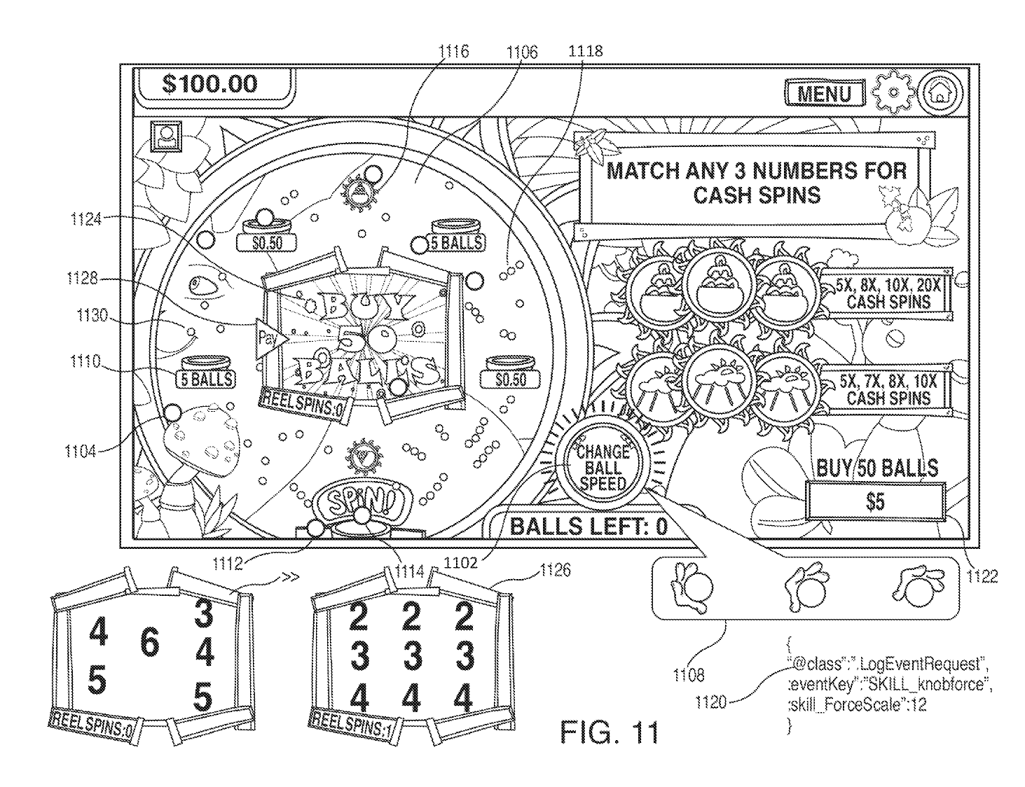

Referring now to FIG. 11, a diagram of an exemplary pachinko-themed electronic game is provided where a knob interface element 1102 is used to control the speed and force used to launch balls from a launcher 1104 into the game's play field 1106. Depending upon the knob interface element setting 1108 as adjusted by the player, a launched ball may land inside a prize pocket 1110, a non-winning pocket 1112, or a “spin” pocket 1114. A player can see obstacles, such as wheels 1116 and nails 1118 visually interact with a ball's ultimate outcome. For this reason, a player may adjust the knob interface element setting 1102 in an attempt to optimize a winning outcome. In turn, player input data 1120 is sent to game play server 120 that describes the player's input at step 314 in FIG. 3. That input may be incorporated into new game output to produce a new set of results or supersede previous game output. When sufficient queued cash win value is available, new awards and outcomes can be generated based upon a more optimal adjustment to the knob interface element 1102 causing a greater percentage of launched balls to land inside a prize pocket 1110 or the “spin” pocket 1114. A skilled player can better recognize which adjustment to the knob interface element 1108 returns the greatest wins when compared with a less-skilled player. As with the methods described in FIG. 6 and FIG. 7, in accordance with an embodiment of the present disclosure, a skilled player will achieve goals that cause cash awards to be disclosed by game server 120 more frequently and/or faster than a less-skilled player.

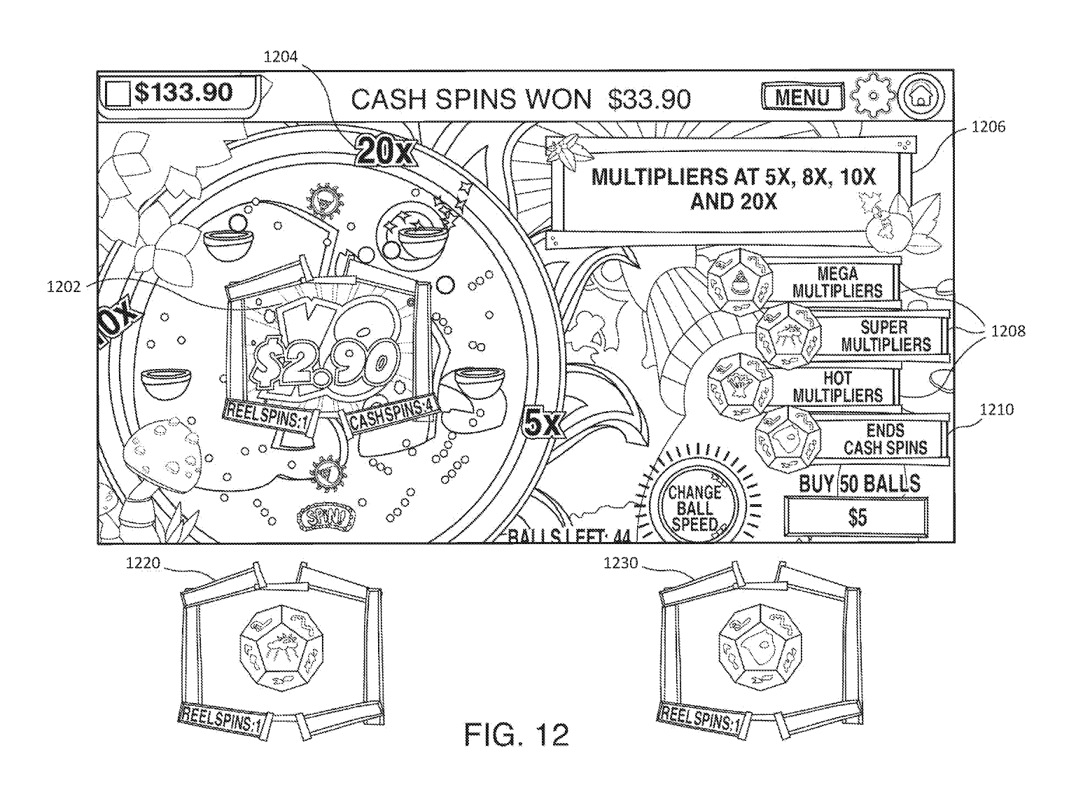

When a ball lands in the “spin” pocket 1114, a slot machine sequence 1122, is activated in interface panel 1124 that can trigger a fever mode game state. In reference to FIG. 12, while fever mode game state is active, balls entering the “spin” pocket 1114 award a cash spin 1202, the result of which can be increased by a multiplier wheel 1204. Further, the set of multipliers present on a multiplier wheel 1206 can change when a spinning die symbol appears during a cash spin 1202. Each die outcome corresponds to a different set of multipliers 1208 or the conclusion of the fever mode game state 1210. The probability of triggering a fever mode game state is influenced by a persistent player state that incorporates the queued cash win value, as well as other game-related factors. For example, a state variable (SV) will initialize at 1. Each individual wager a player makes causes (SV) to increment by an amount corresponding to the cash value of that wager. When game server 120 generates game data corresponding to a ball entering the “spin” pocket 1114, a formula that incorporates (SV) is used to determine the outcome. Thus, the probability of triggering a fever mode game state increases. When a player's (SV) is retrieved by game play server 120 from database 226, it is added to the State Data Package 225a along with the queued cash win value and information from a player's history and other state information related to the player, the game, the game system, time, or any other relevant outside information. Along with the Input Data Package 225b, the State Data Package 225a is used by Game Generation module 225c to generate game output data to be both stored and sent to the player. When sufficient queued cash win value (Q) is available, Game Generation module 225c will increase the probability of triggering the fever mode game state. For example, if (SV) is equal to 1, the probability might equal 1 in 130. While, if (SV) is equal to 21, the probability might equal 1 in 30. Ultimately, the probability of triggering the fever mode game state is also a function of the Input Data Package as a player's input will affect the frequency of balls entering the “spin” pocket 1114. By using (SV) in this calculation, a less skilled player will have a better chance of triggering fever mode game state with fewer balls entering the “spin” pocket 1114.

As noted briefly above, communications between wagering system 110, game play server 120, and gaming device 130 can be offered in different configurations and may include, but are not limited to, direct communication between gaming device 130 and game play server 120, communication between gaming device 130 and game play server 120 via wagering system 110, communication between wagering system 110 and gaming device 130 via game play server 120, direct integration of game play server 120 with wagering system 110, direct integration of game play server 120 with gaming device 130, or other combinations. Communication with and content from external systems, such as the social APIs (such as FACEBOOK® or TWITTER®), can be integrated with any of wagering system 110, game play server 120 and/or gaming device 130, and may be used as external information to drive game outcomes and awards by game play server 120.

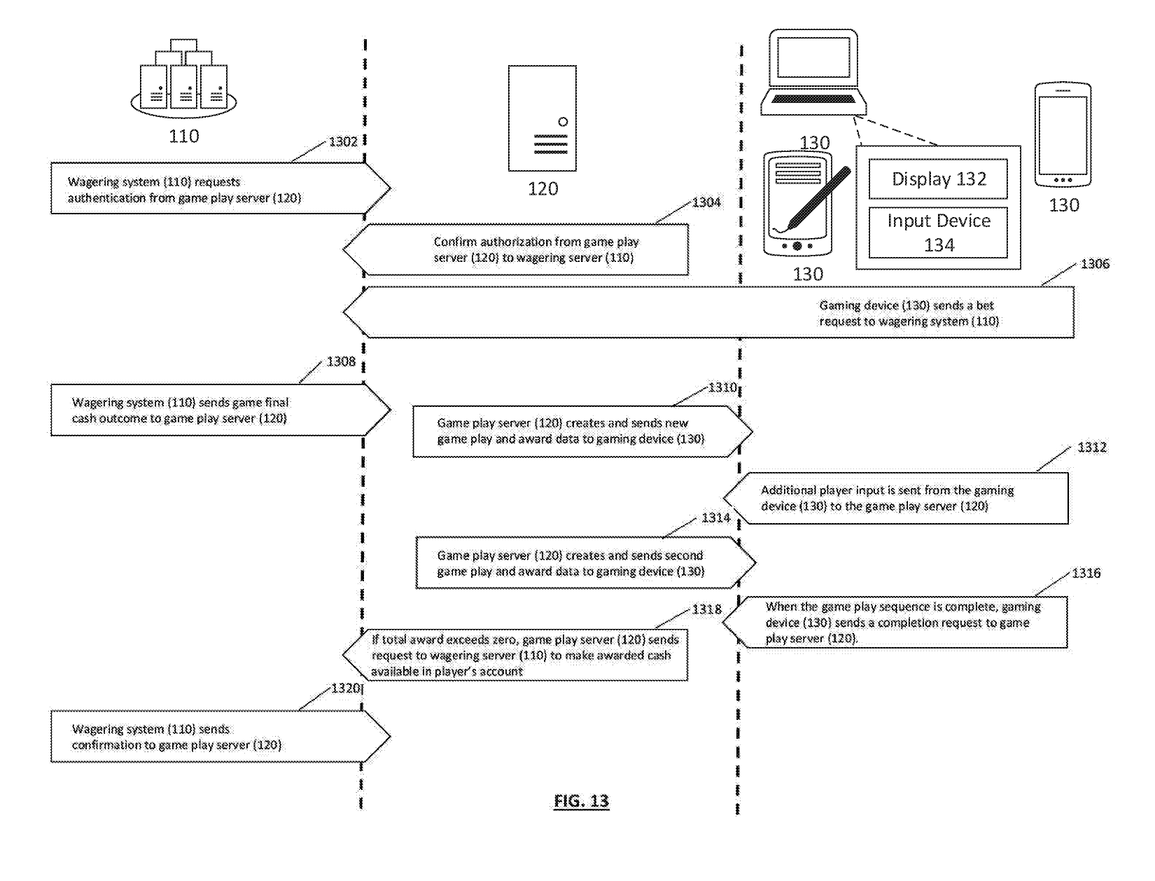

Referring now to FIG. 13, a flow diagram is provided of exemplary computer-implemented communications between wagering system 110, game play server 120, and gaming device 130, in accordance with an embodiment of the present disclosure. Wagering system 110 requests authentication with game play server 120 in block 1302 and a response is returned from game play server 120 to wagering system 110 in block 1304. When authentication is granted, game play server 120 and wagering system 110 may exchange data.

Gaming device 130, which is logged in to wagering system 110 with a funded account, sends a bet request to wagering system 110 in block 1306. The contents of the bet request will include information such as the amount wagered and the game selected. In some embodiments, initial player input information may be included in the game request. In the pachinko game described above, a player may make an adjustment to the knob interface element 1102. The resulting data 1120 is sent to game play server 120 or is forwarded from wagering system 110 to game play server 120 in block 1308. Most importantly, in block 1308, wagering system 110 sends the final cash win outcome for the wager to game play server 120. Game play server 120 creates and sends new game play data and any related award data to gaming device 130 in block 1310. If, in block 1312, gaming device 130 sends additional input to game play server 120, game play server 120 will respond with additional data in block 1314. In an embodiment, this additional data will replace existing data previously sent to gaming device 130. In another embodiment, this additional data will represent events that occur in sequence after the conclusion of events represented in previous data. When the game play sequence is complete, gaming device 130 sends a completion request to game play server 120 in block 1316. If award (A) >0, game play server 120 sends a request to wagering system 110 to disclose a cash value equal to (A) in step 1318. In step 1320, wagering system 110 sends a confirmation to game play server 120 that it has successfully completed the transactions required for the previously undisclosed value of (A) to appear in a player's account.

By implementing the above-described systems, devices, and methods, lottery game play may incorporate skill, decisions, continuity and other known and unknown features previously unavailable under wide-spread lottery rules and practices. These features can prolong time-on-device and increase player enjoyment without having to change existing lottery infrastructures. In particular, the present disclosure incorporates methods and systems to receive a lottery awarded amount and then generate additional electronic games that incrementally reveal portions of the lottery awarded amount to the player over a prolonged period of time and/or series of games. The portrayal and timing of how these awards are revealed are impacted by player decisions, series of conditions that must be met over a sequence of games, and other non-predetermined data. The mechanics of games with decisions and continuity features, such as poker, blackjack, pachinko, fruit machines, and/or quiz machines invite greater time on device for players than games without player interaction or a perceived stake in a future wager. The above-described systems and devices may be added to existing lottery infrastructures simply as an application program interface (API), module or an add-on component.

The systems described herein may also utilize one or more controllers to receive various information and transform the received information to generate an output. The controller may include any type of computing device, computational circuit, or any type other processor or processing circuit capable of executing a series of instructions that are stored in a memory. The controller may include multiple processors and/or multicore central processing units (CPUs) and may include any type of processor, such as a microprocessor, digital signal processor, microcontroller, or the like. The controller may also include a memory to store data and/or algorithms to perform a series of instructions.

Any of the herein described methods, programs, algorithms or codes may be converted to, or expressed in, a programming language or computer program. A “Programming Language” and “Computer Program” includes any language used to specify instructions to a computer, and includes (but is not limited to) these languages and their derivatives: Assembler, Basic, Batch files, BCPL, C, C+, C++, Delphi, Fortran, Java, JavaScript, Machine code, operating system command languages, Pascal, Perl, PL1, scripting languages, Visual Basic, metalanguages which themselves specify programs, and all first, second, third, fourth, and fifth generation computer languages. Also included are database and other data schemas, and any other meta-languages. No distinction is made between languages which are interpreted, compiled, or use both compiled and interpreted approaches. No distinction is also made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Any of the herein described methods, programs, algorithms or codes may be contained on one or more machine-readable media or memory. The term “memory” may include a mechanism that provides (e.g., stores and/or transmits) information in a form readable by a machine such a processor, computer, or a digital processing device. For example, a memory may include a read only memory (ROM), random access memory (RAM), magnetic disk storage media, optical storage media, flash memory devices, or any other volatile or non-volatile memory storage device. Code or instructions contained thereon can be represented by carrier wave signals, infrared signals, digital signals, and by other like signals.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A game play server including a processor and a memory storing instructions which, when executed by the processor, cause the game play server to:
receive data from a wagering system indicating that a player has placed, via a gaming device, a wager with the wagering system, and a result of the wager including an amount won by the player;
increment a queued cash win value with the amount won by the player as indicated in the data received from the wagering system;
generate first game play data representing new game outcomes and cash wins based upon the queued cash win value and previously stored data;
generate second game play data that impacts a future game's outcome and cash wins based upon the queued cash win value;
decrement the queued cash win value with an amount awarded and displayed to the player;
send the first generated game play data to the player via the gaming device;
store the second generated game play data; and
send a request to the wagering system to update a gaming account associated with the player to indicate that the awarded amount is payable.

2. The game play server of claim 1, wherein the memory stores further instructions which, when executed by the processor, cause the game play server to, send a request to the wagering system to update the gaming account associated with the player to indicate that a remaining balance in the gaming account is payable.

3. The game play server of claim 1, wherein a balance of unpaid cash winnings in the gaming account associated with the player is maintained undisclosed to the player.

4. The game play server of claim 1, wherein the second awarded amount is different from the first awarded amount.

5. The game play server of claim 1, wherein the memory stores further instructions which, when executed by the processor, cause the game play server to, after sending the request to the wagering system to update the gaming account associated with the player to indicate that the awarded amount is payable, receive second data from the wagering system indicating that the player has placed, via a gaming device, a second wager with the wagering system, and a result of the second wager including a second amount won by the player; and
increment the queued cash win value with the second amount won by the player as indicated in the second data received from the wagering system.

6. The game play server of claim 1, wherein the game play data includes multiple events and a set of conditions to be met.

7. The game play server of claim 6, wherein predetermined ones of the multiple events meet conditions of the set of conditions.

8. The game play server of claim 1, wherein the game play server forms part of the wagering system.

9. The game play server of claim 1, wherein the generated game play data allows the player to play a game which is independent from a game hosted by the wagering system.

10. The game play server of claim 1, wherein the memory stores further instructions which, when executed by the processor, cause the game play server to generate game play data which enriches a game hosted by the wagering system

11. The game play server of claim 1, wherein the memory stores further instructions which, when executed by the processor, cause the game play server to generate game play data impacted by a player state.

12. The game play server of claim 1, wherein the memory stores further instructions which, when executed by the processor, cause the game play server to generate game play data impacted by time.

13. The game play server of claim 1, wherein the memory stores further instructions which, when executed by the processor, cause the game play server to generate game play data impacted by a player selection.

14. The game play server of claim 1, wherein the memory stores further instructions which, when executed by the processor, cause the game play server to generate game play data impacted by player skill.

15. The game play server of claim 1, wherein the memory stores further instructions which, when executed by the processor, cause the game play server to generate game play data impacted by a game state.

16. The game play server of claim 1, wherein the memory stores further instructions which, when executed by the processor, cause the game play server to generate game play data impacted by a persistent player state.

17. The game play server of claim 1, wherein the memory stores further instructions which, when executed by the processor, cause the game play server to generate game play data impacted by lottery drawing outcomes.

18. The game play server of claim 1, wherein the memory stores further instructions which, when executed by the processor, cause the game play server to generate game play data impacted by sports outcomes.

19. The game play server of claim 1, wherein the generated second game play data is related to the generated game play data such that the player is allowed to play a continuous game.

20. A method for operating a computerized game, the method comprising:
receiving data from a wagering system indicating that a player has placed, via a gaming device, a wager with the wagering system, and a result of the wager including an amount won by the player;
incrementing a queued cash win value with the amount won by the player as indicated in the data received from the wagering system;
generating first game play data representing new game outcomes and cash wins based upon the queued cash win value and previously stored data;
generating second game play data that impacts a future game's outcome and cash wins based upon the queued cash win value;
decrementing the queued cash win value with an amount awarded and displayed to the player;
sending the first generated game play data to the player via the gaming device;
storing the second generated game play data; and
sending a request to the wagering system to update a gaming account associated with the player to indicate that the awarded amount is payable.

21. The method of claim 20, further comprising sending a request to the wagering system to update the gaming account associated with the player to indicate that a remaining balance in the gaming account is payable.

22. The method of claim 20, wherein a balance of unpaid cash winnings in the gaming account associated with the player is maintained undisclosed to the player.

23. The method of claim 20, wherein the second awarded amount is different from the first awarded amount.

24. The method of claim 20, further comprising:
after sending the request to the wagering system to update the gaming account associated with the player to indicate that the awarded amount is payable, receiving second data from the wagering system indicating that the player has placed, via a gaming device, a second wager with the wagering system, and a result of the second wager including a second amount won by the player; and
incrementing the queued cash win value with the second amount won by the player as indicated in the second data received from the wagering system.

25. The method of claim 20, wherein the game play data includes multiple events and a set of conditions to be met.

26. The method of claim 25, wherein predetermined ones of the multiple events meet conditions of the set of conditions.

27. The method of claim 20, wherein the generated game play data allows the player to play a game which is independent from a game hosted by the wagering system.

28. The method of claim 20, further comprising generating game play data which enriches a game hosted by the wagering system

29. The method of claim 20, further comprising generating game play data impacted by a player state.

30. The method of claim 20, further comprising generating game play data impacted by time.

31. The method of claim 20, further comprising generating game play data impacted by a player selection.

32. The method of claim 20, further comprising generating game play data impacted by player skill.

33. The method of claim 20, further comprising generating game play data impacted by a game state.

34. The method of claim 20, further comprising generating game play data impacted by a persistent player state.

35. The method of claim 20, further comprising generating game play data impacted by lottery drawing outcomes.

36. The method of claim 20, further comprising generating game play data impacted by sports outcomes.

37. The method of claim 20, wherein the generated second game play data is related to the generated game play data such that the player is allowed to play a continuous game.

38. A non-transitory computer-readable storage medium storing a computer program including instructions which, when executed by a processor, cause a computer to:
receive data from a wagering system indicating that a player has placed, via a gaming device, a wager with the wagering system, and a result of the wager including an amount won by the player;
increment a queued cash win value with the amount won by the player as indicated in the data received from the wagering system;
generate first game play data representing new game outcomes and cash wins based upon the queued cash win value and previously stored data;
generate second game play data that impacts a future game's outcome and cash wins based upon the queued cash win value;
decrement the queued cash win value with an amount to be awarded and displayed to the player;
send the first generated game play data to the player via the gaming device;
store the second generated game play data; and
send a request to the wagering system to update a gaming account associated with the player to indicate that the awarded amount is payable.

39. The computer-readable storage medium of claim 38, wherein the computer program further includes instructions which, when executed by the processor, cause the computer to, send a request to the wagering system to update the gaming account associated with the player to indicate that a remaining balance in the gaming account is payable.

40. The computer-readable storage medium of claim 38, wherein a balance of unpaid cash winnings in the gaming account associated with the player is maintained undisclosed to the player.

41. The computer-readable storage medium of claim 38, wherein the second awarded amount is different from the first awarded amount.

42. The computer-readable storage medium of claim 38, wherein the computer program further includes instructions which, when executed by the processor, cause the computer to, after sending the request to the wagering system to update the gaming account associated with the player to indicate that the awarded amount is payable, receive second data from the wagering system indicating that the player has placed, via a gaming device, a second wager with the wagering system, and a result of the second wager including a second amount won by the player; and
increment the queued cash win value with the second amount won by the player as indicated in the second data received from the wagering system.

43. The computer-readable storage medium of claim 38, wherein the game play data includes multiple events and a set of conditions to be met.

44. The computer-readable storage medium of claim 43, wherein predetermined ones of the multiple events meet conditions of the set of conditions.

45. The computer-readable storage medium of claim 38, wherein the generated game play data allows the player to play a game which is independent from a game hosted by the wagering system.

46. The computer-readable storage medium of claim 38, wherein the computer program further includes instructions which, when executed by the processor, cause the computer to generate game play data which enriches a game hosted by the wagering system

47. The computer-readable storage medium of claim 38, wherein the computer program further includes instructions which, when executed by the processor, cause the computer to generate game play data impacted by a player state.

48. The computer-readable storage medium of claim 38, wherein the computer program further includes instructions which, when executed by the processor, cause the computer to generate game play data impacted by time.

49. The computer-readable storage medium of claim 38, wherein the computer program further includes instructions which, when executed by the processor, cause the computer to generate game play data impacted by a player selection.

50. The computer-readable storage medium of claim 38, wherein the computer program further includes instructions which, when executed by the processor, cause the computer to generate game play data impacted by player skill.

51. The computer-readable storage medium of claim 38, wherein the computer program further includes instructions which, when executed by the processor, cause the computer to generate game play data impacted by a game state.

52. The computer-readable storage medium of claim 38, wherein the computer program further includes instructions which, when executed by the processor, cause the computer to generate game play data impacted by a persistent player state.

53. The computer-readable storage medium of claim 38, wherein the computer program further includes instructions which, when executed by the processor, cause the computer to generate game play data impacted by lottery drawing outcomes.

54. The computer-readable storage medium of claim 38, wherein the computer program further includes instructions which, when executed by the processor, cause the computer to generate game play data impacted by sports outcomes.

55. The computer-readable storage medium of claim 38, wherein the generated second game play data is related to the generated game play data such that the player is allowed to play a continuous game.
